(19) United States
(12) Patent Application Publication
(10) Pub. No.: US 2012/0098250 A1
(43) Pub. Date: Apr. 26, 2012

(54) PIPE JOINT STRUCTURE

(76) Inventors: YEO-SHAN CHANG, Din-Feu Lukang (TW); Wen-Shan Chang, Din-Feu Lukang (TW)

(21) Appl. No.: 12/908,094

(22) Filed: Oct. 20, 2010

(51) Int. Cl. F16L 55/00

(52) U.S. Cl. 285/18

(57) ABSTRACT

A pipe joint structure for an upright valve includes a pipe joint, a resilient ring, a connection cylinder and an inner sleeve. The pipe joint includes a first chamber to receive a positioning ring and a seal ring. The resilient ring, the connection cylinder and the inner sleeve are inserted in the pipe joint in sequence. When a connection pipe is inserted in the pipe joint, the connection pipe will be inserted in a one-way direction and fastened by fastening talons of the resilient ring. To disengage the connection pipe, top push flanges of resilient claws of the inner sleeve are pushed to an inner limit inclined surface of the positioning ring to disengage the connection pipe from the fastening talons, such that the connection pipe can be pulled out. The present invention provides a quick connection and can prevent the connection pipe from being pulled out unexpectedly.

### BACKGROUND OF THE INVENTION

1. Field of the Invention

The present invention relates to a pipe joint structure.

2. Description of the Prior Art

A conventional upright valve includes a pipe joint under the upright valve. The pipe joint has a threaded pipe to connect a connection pipe. The connection pipe is threadedly connected to the pipe joint, which consumes a lot of time and labor. The connection of the connection pipe and joint pipe cannot be done outside and then connected to the upright valve, which must be coupled separately. The traditional connection way wastes a lot of time and manpower. Besides, in this connection way, the joint between pipe joint and the connection pipe may leak water.

### SUMMARY OF THE INVENTION

The primary object of the present invention is to provide a pipe joint structure for an upright valve. The pipe joint structure comprises a pipe joint, a resilient ring, a connection cylinder and an inner sleeve. The pipe joint includes a receiving pipe, a concave recess disposed at one end of the receiving pipe, and a first chamber above the concave recess. A positioning ring and a seal ring are received in the first chamber. The seal ring is located at an upper end of the first chamber and above the positioning ring. The positioning ring is located in the first chamber and under the seal ring. The positioning ring has an inner limit inclined surface. The resilient ring includes a plurality of fastening talons which are slightly slanted upward to fasten an outer wall of a connection pipe. The resilient ring is clamped between the positioning ring and the inner sleeve and located in the first chamber. The connection cylinder includes an outer raised portion to engage with the concave recess, a protruding ring at one end thereof, a second chamber above the protruding ring, and a stepped groove on an inner rim thereof. The protruding ring has an upper blocking surface and a lower sliding surface. The connection cylinder is located in the first chamber. The inner sleeve includes a plurality of resilient claws each having an inclined top push flange and a stop surface under the top push flange. The inner sleeve further includes a push plate at a bottom end thereof. The inner sleeve is slid in the second chamber from the sliding surface with the stop surfaces of the resilient claws to engage with the blocking surface. Thereby, when the connection pipe is inserted and pushed in the pipe joint from the inner sleeve, the connection pipe is inserted in a one-way direction along an inner side of the resilient ring. The connection pipe is fastened by the fastening talons. When the connection pipe is pulled outward, the connection pipe brings the fastening talons to move the resilient ring outward, the stepped groove of the connection cylinder confines movement of the resilient ring, so that the connection pipe is further fastened by the fastening talons to prevent the connection pip from disengagement in a reverse direction. The push plate of the inner sleeve is pressed when disengaging the connection pipe, the top push flanges of the resilient claws are pushed to the inner limit inclined surface of the positioning ring along the inner side of the resilient ring to disengage the connection pipe from the fastening talons and the connection pipe is pulled out.

Preferably, the resilient ring is provided with a number of fastening talons to enhance its fastening force.

### BRIEF DESCRIPTION OF THE DRAWINGS

FIG. 1 is an exploded view according to a preferred embodiment of the present invention;

FIG. 2 is another exploded view according to the preferred embodiment of the present invention;

FIG. 3 is a perspective view according to the preferred embodiment of the present invention;

FIG. 4 is a cross-sectional view according to the preferred embodiment of the present invention;

FIG. 5 is a cross-sectional view according to the preferred embodiment of the present invention in an operating status; and

FIG. 6 is an enlarged cross-sectional view according to the preferred embodiment of the present invention.

### DETAILED DESCRIPTION OF THE PREFERRED EMBODIMENTS

Embodiments of the present invention will now be described, by way of example only, with reference to the accompanying drawings.

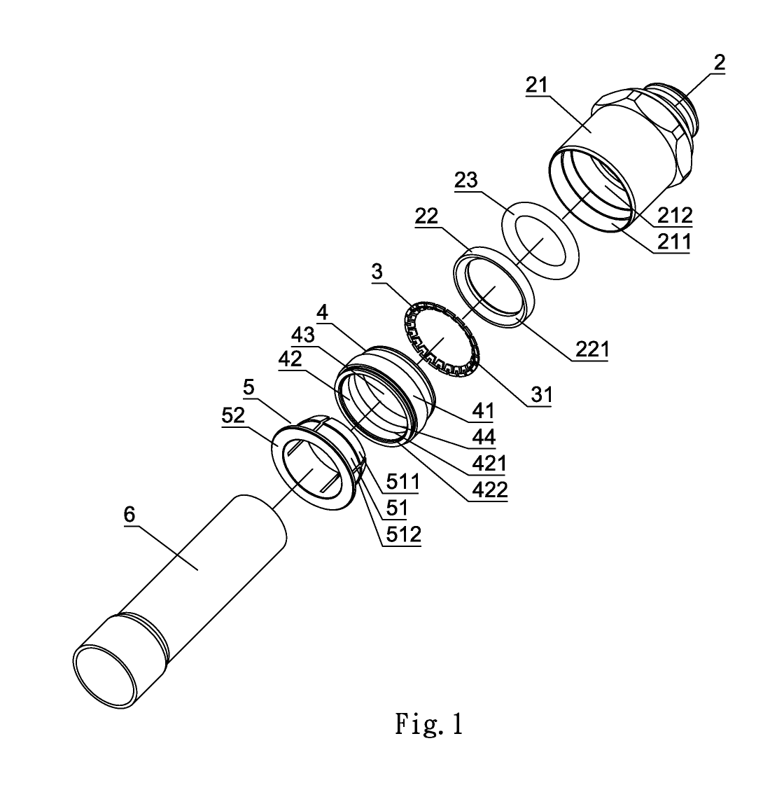

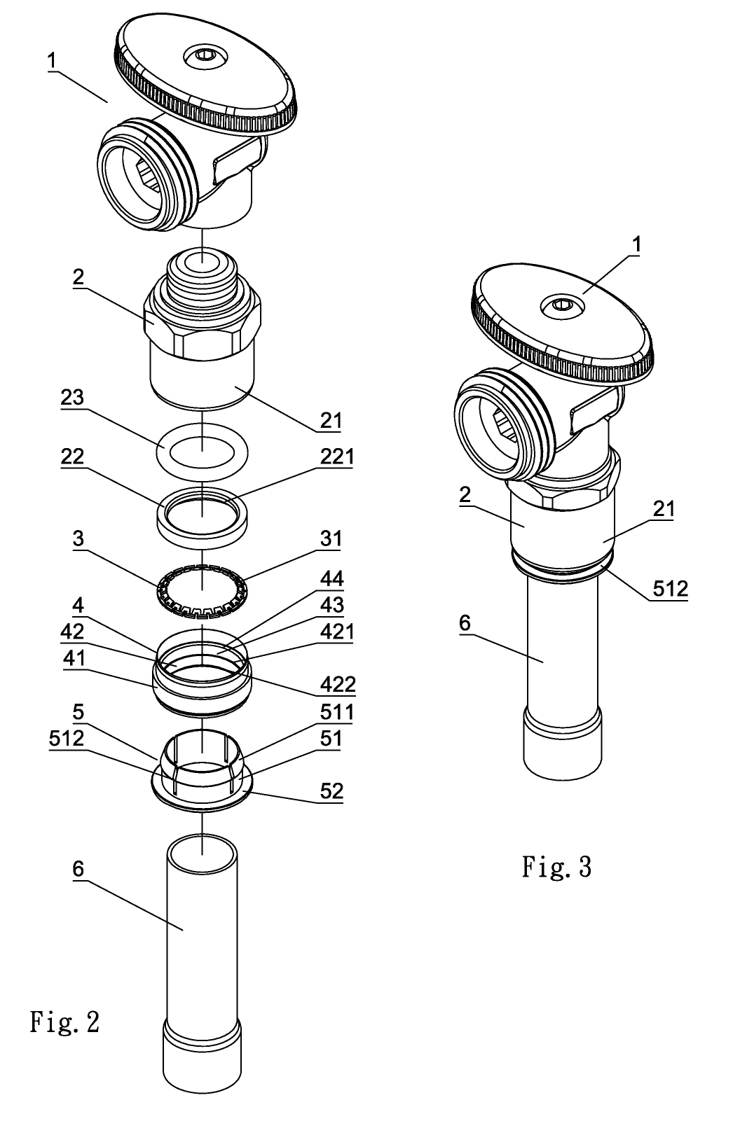

As shown in FIG. 1 through FIG. 4, a pipe joint structure according to a preferred embodiment of the present invention comprises a pipe joint 2 coupled to an upright valve 1, a resilient ring 3, a connection cylinder 4 and an inner sleeve 5.

The pipe joint 2 includes a receiving pipe 21, a concave recess 211 disposed at one end of the receiving pipe 21, a first chamber 212 above the concave recess, a positioning ring 22 and a seal ring 23 received in the first chamber 212. The positioning ring 22 has an inner limit inclined surface 221.

The resilient ring 3 includes a plurality of fastening talons 31 which are slightly slanted upward for one-way insertion of a connection pipe 6 so as to engage with the outer wall of the connection pipe 6. The resilient ring 3 is clamped between the positioning ring 22 and the inner sleeve 5.

The connection cylinder 4 includes an outer raised portion 41 to engage with the concave recess 211, a protruding ring 42 at one end thereof, a second chamber 43 above the protruding ring 42, and a stepped groove 44 on an inner rim thereof. The protruding ring 42 has an upper blocking surface 421 and a lower sliding surface 422 for resilient claws 51 of the inner sleeve 5 to be slid and positioned thereat. The second chamber 43 and the stepped groove 44 are to receive the inner sleeve 5 and to stop the resilient ring 3, respectively.

The inner sleeve 5 includes the resilient claws 51 each having an inclined top push flange 511 and a stop surface 512 under the top push flange 511 to be inserted in the protruding ring 42 of the connection pipe 4. The inner sleeve 5 further includes a push plate 52 at a bottom end thereof for the user to push thereon. The present invention provides a quick and simple way to connect and fasten the connection pipe.

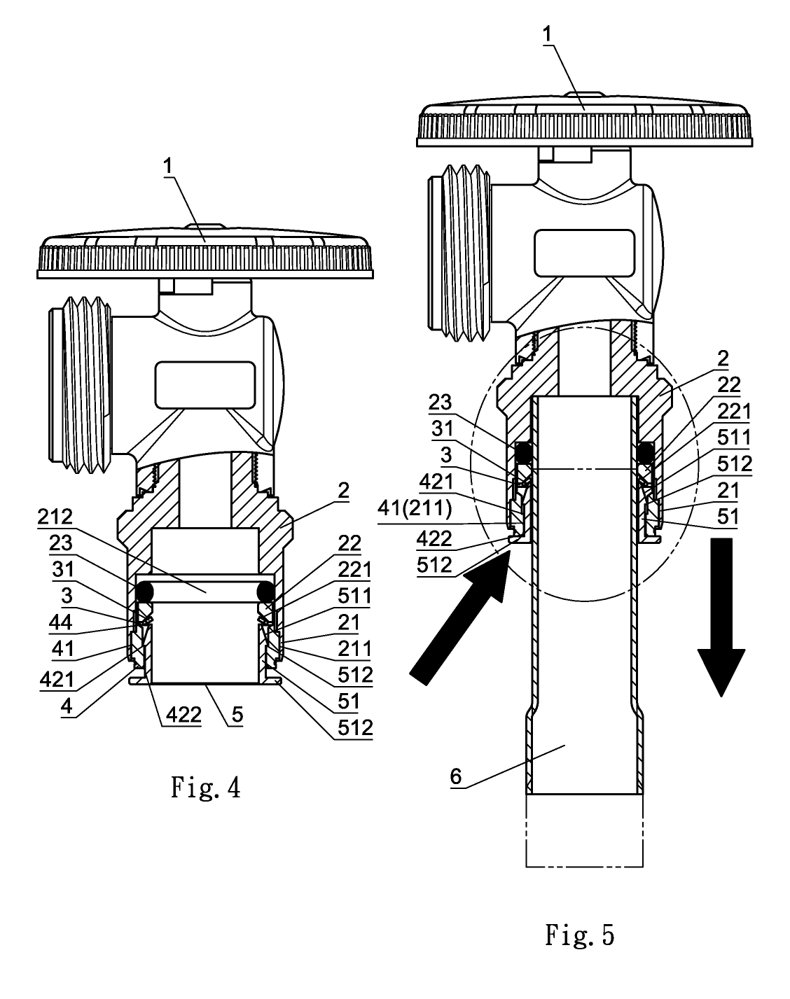

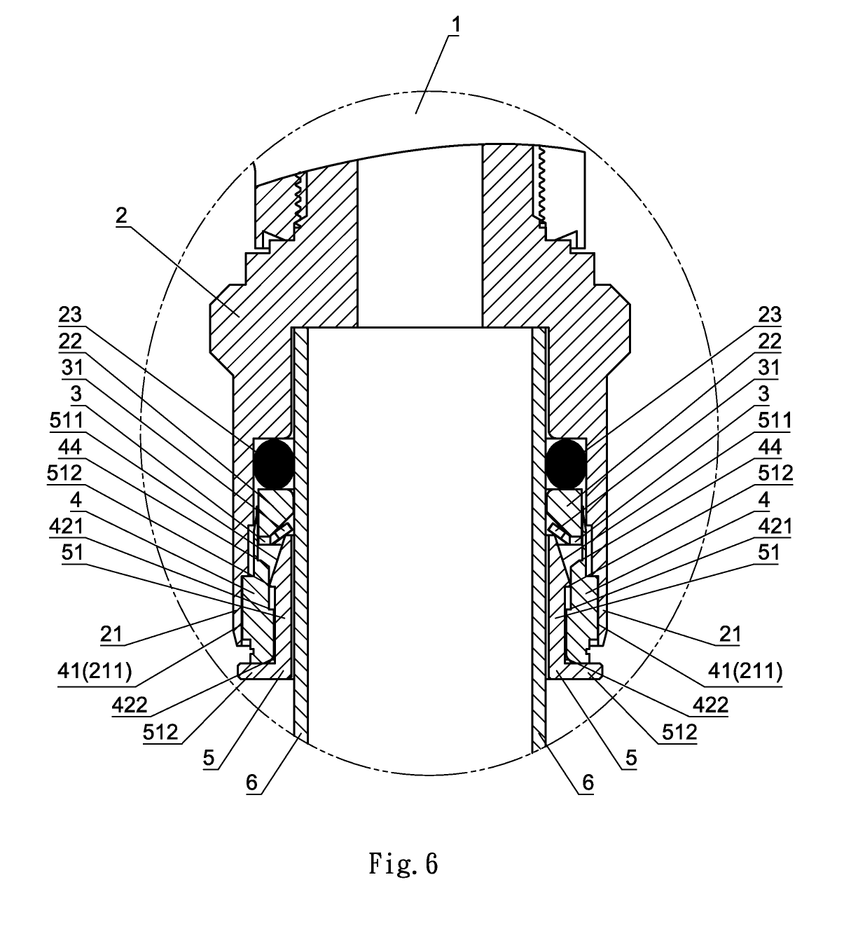

Referring to FIG. 1 through FIG. 4, the connection cylinder 4 is inserted in the receiving pipe 21 with the outer raised portion 41 to engage thereon. The resilient ring 3 is located between the stepped groove 44 and the positioning ring 22. The inner sleeve 5 is slid in the second chamber 43 from the sliding surface 422 with the stop surface 512 of each resilient claw 51 to engage with the blocking surface 421, as shown in FIG. 4 so as to prevent disengagement. Referring to FIG. 3, FIG. 5, and FIG. 6, when the connection pipe 6 is inserted in the pipe joint 2 from the inner sleeve 5, the connection pipe 6 will be inserted in a one-way direction along the inner side of the fastening talons 31 of the resilient ring 3. The connection pipe 6 is fastened by the fastening talons 31, as shown in FIG. 5 and FIG. 6. When the connection pipe 6 is pulled outward, the connection pipe 6 brings the fastening talons 31 to move the resilient ring 3 outward. The stepped groove 44 of the connection cylinder 4 confines the movement of the resilient ring 3, so that the connection pipe 6 is further fastened by the fastening talons 31 so as to prevent the connection pip 6 from disengagement in a reverse direction, as shown in FIG. 4 and FIG. 6. To disengage the connection pipe 6, the user presses the push plate 52 of the inner sleeve 5. The top push flanges 511 of the resilient claws 51 are pushed to the inner limit inclined surface 221 of the positioning ring 22 along the inner side of the resilient ring 3 to disengage the connection pipe 6 from the fastening talons 31, such that the connection pipe 6 can be pulled out. The present invention provides a quick connection and can prevent the connection pipe from being pulled out unexpectedly.

The resilient ring 3 can be provided with a plurality of fastening talons 31 to enhance its fastening force.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pipe joint structure for an upright valve, comprising:
a pipe joint including a receiving pipe, a concave recess disposed at one end of the receiving pipe, a first chamber above the concave recess, a positioning ring and a seal ring received in the first chamber;
the seal ring located at an upper end of the first chamber and above the positioning ring;
the positioning ring located in the first chamber and under the seal ring, the positioning ring having an inner limit inclined surface;
a resilient ring including a plurality of fastening talons which are slightly slanted upward to fasten an outer wall of a connection pipe, the resilient ring being clamped between the positioning ring and an inner sleeve and located in the first chamber;
a connection cylinder including an outer raised portion to engage with the concave recess, a protruding ring at one end thereof, a second chamber above the protruding ring, and a stepped groove on an inner rim thereof, the protruding ring having an upper blocking surface and a lower sliding surface, the connection cylinder being located in the first chamber,
the inner sleeve including a plurality of resilient claws each having an inclined top push flange and a stop surface under the top push flange, the inner sleeve further including a push plate at a bottom end thereof, the inner sleeve being slid in the second chamber from the sliding surface with the stop surfaces of the resilient claws to engage with the blocking surface;
thereby, when the connection pipe being inserted and pushed in the pipe joint from the inner sleeve, the connection pipe being inserted in a one-way direction along an inner side of the resilient ring, the connection pipe being fastened by the fastening talons, when the connection pipe being pulled outward, the connection pipe bringing the fastening talons to move the resilient ring outward, the stepped groove of the connection cylinder confining movement of the resilient ring so that the connection pipe is further fastened by the fastening talons to prevent the connection pip from disengagement in an opposing direction, the push plate of the inner sleeve being pressed when disengaging the connection pipe from the fastening talons, the top push flanges of the resilient claws being pushed to the inner limit inclined surface of the positioning ring along the inner side of the resilient ring to disengage the connection pipe from the fastening talons and the connection pipe being pulled out.

2. The pipe joint structure for an upright valve of claim 1, wherein the resilient ring is provided with a number of fastening talons to enhance its fastening force.
